(19) United States
(12) Patent Application Publication
(10) Pub. No.: US 2006/0246411 A1
(43) Pub. Date: Nov. 2, 2006

(54) Learning apparatus and method

(76) Inventor: Steven P. Yang, Palo Alto, CA (US)

Correspondence Address: CHARMASSON, BUCHACA & LEACH, LLP, 1545 HOTEL CIRCLE SOUTH, SUITE 150, SAN DIEGO, CA, 92108-3426, US

(21) Appl. No.: 11/412,497

(22) Filed: Apr. 27, 2006

Related U.S. Application Data
(60) Provisional application No. 60/675,522, filed on Apr. 27, 2005.

(51) Int. Cl. G09B 7/00

(52) U.S. Cl. 434/323

(57) ABSTRACT

A learning aid which can be implemented in computer software where a user's responses to a timed worksheet are used to adjust parameters used in selecting the problems and time limit in a successively timed worksheet. Parameters can include problem complexity, the mode or type of problems having a given complexity, the number of problems, worksheet time limit, and measures of user performance including time remaining and the number of correct, incorrect and non-completed answers to problems. Performance is tracked over successive worksheets in order to arrive at a user's competency level and to provide the user feedback tailored to enhance the learning experience.

### PRIOR APPLICATION

This application claims the benefit of U.S. Provisional Application Ser. No. 60/675,522 filed Apr. 27, 2005.

### INCORPORATION BY REFERENCE

All of the prior published documents that are referenced herein, including website publications as of the date on or about the initial filing of this application, are incorporated in their entirety herein by reference.

### FIELD OF THE INVENTION

This invention relates to operator learning aids, other related learning devices, and learning methods for device operators. More particularly in one electronic device embodiment for improving learning of a topic by an operator, the learning aid has 1) a computer, 2) means for presenting computer-generated responses to the operator, and 3) means for receiving operator inputs operably connected to said computer. In one method embodiment, the invention relates to an interactive method of teaching mathematical concepts.

### BACKGROUND

A variety of electronic learning devices are known in the art. For example, U.S. Pat. No. 5,681,170, Rieber et al., incorporated herein by this reference, discloses an electronic learning apparatus that presents an operator with sets of problems having self-adjusting levels of difficulty or “learning ladder levels.” In essence, each ladder level represents a set of problems with a different level of learning difficulty. For example, if the operator answers a current set of problems at one level correctly, the operator is presented with a set of problems with a higher level of difficulty. If the operator answers one problem incorrectly, a set of problems at a lower level is presented. In essence, a new set of problems is generated at an adjacent difficulty level depending upon whether the previous set of problems was answered correctly or not.

However, this approach has shortcomings. One shortcoming is an intolerance for some types of operator learning difficulties. For example, a student or other operator may not understand a concept that is required to correctly answer questions at one difficulty level. This type of student theoretically enters an endless loop of satisfactorily answering questions on an initial level, being presented questions at the next adjacent higher level, failing to understand the concept at this higher level, incorrectly answering questions at this higher level, then being returned to again answer repetitive questions at the initial difficulty level.

Another shortcoming is essentially a rigid methodology. For example, an operator who fully understands the concepts required at a specific learning level may try to quickly finish the corresponding problem set and make minor typographical errors in the process. These minor errors then lead to operator frustration when the operator is presented with questions at the next lower difficulty level only to be again presented with similar and learning-useless questions at the initial level.

In another example, the user or operator of a prior art learning device may understand the concepts required at a learning ladder level, but be faced with an inability to master questions that are presented by the device at that level unless outside assistance is provided, e.g., the operator misunderstands the questions. But the operator may not realize outside assistance is needed (or is ashamed to admit outside assistance is needed) and does not progress in his or her learning until assistance is somehow provided outside of the device.

### SUMMARY

The present learning device and process invention measures a plurality of operator performance measures (rather than just the correctness of an operator's answers at a given difficulty) when the operator is presented with a set of problems. Based on at least two performance measures, at least one algorithm device selects from various device response options rather than only adjusting the next problem sets to an adjacent difficulty or complexity. In addition, the learning device may assign a performance or milestone level rating based upon the performance measures.

Presentation variables, performance measures, and possible device response options include: assigning a complexity to a first set of problems in a presentation, measuring the correctness and time needed to answer the first set of problems, and the device responding with a second set of problems that may have a complexity that is unchanged or changed to an adjacent complexity or changed to a non-adjacent complexity; assigning a restriction on the range of possible problems within a complexity (the restricted range referred to as a mode), measuring the elapsed time for the operator to complete several sets of problems as well as the correctness of the answers, and the device responding with a second set of problems that may have a mode that is unchanged or changed; assigning a time to answer a first set of problems, measuring a time to correctly answer the set and the device responding with a second set of problems requiring a time limit that may be unchanged or changed incrementally or changed by several increments; assigning a total number of problems in a first set, measuring the total number of problems answered correctly, and the device responding with a number of problems in a second set of problems that may be unchanged or changed incrementally or changed by several increments; measuring the elapsed time from prior operator responses or log-on (e.g., as an indicator of whether short-term or long-term memory is needed to recall prior competence) and the device responding by reducing the number and/or complexity of the next set of problems when the elapsed time is more than a set value (e.g., for the next problem set to act as a review); recording past performance measures for problem sets completed at least a day before the current session and, if past performance measures were good, the device responding by further incrementing mode and/or complexity for the next set of problems; and comparing erroneous answers to the first set of problems, if any, to answers indicating a particular type of error by the operator and the device responding with additional information and examples to correct the noted type of error. In addition, one or more of the performance measures may be the basis for a degree of performance competence measure or milestone rating within a topic, e.g., a rating that may serve to indicate the learning progress of an operator or user.

Selection algorithms (and parameters selected for the next data or question set) vary with the application and may not consider each performance parameter (and associated performance measures) in isolation from others. For example, algorithms to select complexity, mode, time to solve a problem set, and the number of problems may use various past performance measures.

In a typical example, besides randomly generating a specific number of questions (e.g., at a specific mode and/or complexity) in a set to be answered within a specific time limit in a presentation, the device response may also include non-problem set responses in a presentation to be transmitted to an operator. Non-problem set presentations may include providing clues for some types of questions (e.g., clues provided in response to a type of erroneous answer), providing additional clues on topics (e.g., if a similar type of erroneous answer continue to be supplied by the operator), providing sample answers (e.g., if appropriate at the beginning of a new milestone), and sending alarms to the operator and/or others, e.g., notifying a teacher that the responses indicate a different operator, perhaps a parent, is responding instead of the listed student.

Using the device and method results in more closely matching the multi-measured performance capabilities of a device user or operator with the challenge posed by device presentations. The matched presentation can provide a challenging, but attainable learning process for a variety of users. The device and method also avoids much operator frustration. It also allows operators to advance at a variable pace and teachers or parents to monitor and reward operators for performance measures that show good effort (e.g., the total amount of time using the device), extracurricular effort (e.g., the amount of time using the device outside of class hours), improvement in one or another subjects (e.g., the increases in mode and/or complexity), as well as overall performance, e.g., advancing past several milestone ratings in a short time and/or doing well on a standardized subject test.

### BRIEF DESCRIPTION OF THE DRAWING

FIG. 1 shows a schematic representation of an inventive learning device.

FIG. 2 shows an example of one milestone chart.

FIG. 3 is a schematic of an architecture embodiment of the invention.

FIG. 4 explains the relevance of the lines in boxes shown in FIG. 5-7.

FIG. 5 shows how milestone ratings can be reached when the operators shows great performance.

FIG. 6 shows an option of what happens when a user reaches a milestone level that challenges the user.

FIG. 7 shows how the invention may reduce a rating/level for operator performance below expectations.

### DESCRIPTION OF THE PREFERRED EMBODIMENT

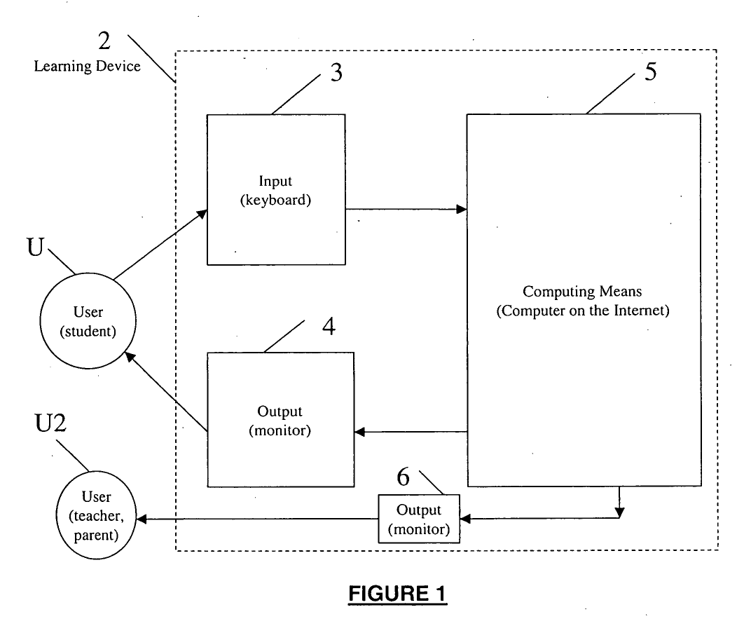

FIG. 1 is a schematic representation of an inventive apparatus embodiment, specifically, an electronic learning device or system 2 for use by operator or user U. The learning device 2 includes a computer or other means for computing 5, an operator means for inputting or other computer input means 3 that is connected electronically or otherwise operably connected to the computing means, and a means for outputting to the operator or other operator presenting means 4 operably connected to the computing means. The input means 3 typically transforms responses by the operator or user U into electronic signals that are input to the computing means 5. An optional means for notifying 6 allows another person U2 to receive information about the user U from computing means 5, e.g., means for sending a computer-generated message to a teacher and/or parent of the user.

The electronic learning aid or device 2 is a system of components that assists in the education or other learning of user U. Examples of device-aided learning can include vocational or other skill training for the user U, high school or college level course instruction, advanced professional training, elementary school course instruction, gaming instructions, and standardized test preparation. Although the user U is herein assumed to be a human being, other animals or other devices capable of learning may also use the learning device 2.

Examples of operator input means 3 include a keyboard, a touch screen, a mouse, an electric or optical or other type of operator-controlled signal switch, a scanner, a video camera, a game controller, a voice recognition device, a motion sensor of one or more portions of an operator's body, and a brain wave monitor. The operator input means 3 may also allow multiple operators at spaced apart locations to make inputs to the computing means 5. In a preferred embodiment, the operator input means 3 is a keyboard connected to a computer 5 via Internet connections. In alternative embodiments, operator input means 3 transmits and/or transduces operator-controlled inputs into non-electronic signals that are computer readable, e.g., laser signals, chemical signals, fluid transmission signals, atomic or other particle/wave signals, pressure signals, and heat signals.

The operator input means 3 can also provide a means for measuring at least two measures or aspects of the user's performance in responding to presentations by the device 2. The user or operator performance measures may include the quickness and range of motion of a finger or other parts of an operator's body, motions of devices controlled by an operator U, time between responsive operator signals, time between posing of a question or questions and responsive operator signal, blink rate, verbal sound waves or other vibrations controlled by an operator, a change in pressure or force exerted by an operator, chemical changes (e.g., perspiration changes), brain wave signals, and other measures dependent at least in part on the operator's reaction. In one preferred embodiment, the operator's responses are keystroke signals from a keyboard transduced by the keyboard into electronic signals transmitted to the computing means 5, e.g., timing and strokes of numbered keys representing a numerical answer by an operator U to a question posed by the computing means and displayed on presentation means 4 of the learning device 2.

The means for outputting or presenting means 4 transduces computer-generated electronic or other system signals into operator-detectable signals and presents them to the user U. Examples of presentation means 4 include a video display screen or other visual signal transmitter, a speaker or other audio signal transmitter, a vibrator or other touch signal transmitter, brain wave probes, and subliminal displays. The presentation means 4 and/or an optional notification means 6 may also allow a plurality of operators (U and U2) or others at various, perhaps remote locations to detect outputs from the computing means 5, e.g., electronic computer outputs transmitted over long distances in electronic or other forms that can be remotely detected and transformed into human sensory-detectable forms. In a preferred embodiment, the presentation means 4 and optional notification means 6 are audio/video consoles and/or related devices connected to an Internet system that is also connected to computing means 5. In an alternative embodiment, the presentation means 4 and the operator input means 3 are essentially combined into one device, e.g., a touch-screen video display.

The system or computer responses (to inputs from operator U transduced through means for inputting 3) are typically selected and generated by computing means 5 using data sets and/or algorithms and in many cases include a set of questions transmitted and transduced by presentation means 4. The system responses may take a variety of forms that are based at least in part on operator performance measures and question parameters, including requests for an identifier (e.g., an operator identifier, passwords, input means identifier, and/or system identifiers), a set of stored or generated questions, randomly generated questions within a prior mode and/or complexity, questions within a different milestone, mode or complexity if operator's prior answers so indicate by means of algorithms, providing clues for prior or current questions, providing different clues if a type of erroneous operator answers continue, providing sample answers, setting or adjusting milestones within a milestone level, incrementally or otherwise adjusting complexity or mode within a milestone rating (e.g., increasing the number of significant digits in a question involving the same concept as prior questions), providing an initial review level that can quickly be changed if responses so indicate, sending alarms to the operator U and/or others U2, e.g., notification to a teacher that the responses indicate different operator is responding instead of the listed user.

The learning system 2 may also select and present context-based dynamic solution explanations to the user U if one or more operator performance or response measures so indicate. In an example of an operator response that indicates an explanation is desired for improved learning, one of the problems presented is 5+(−3) and a student user U responds with an answer of 8. Eight is a specific type of mistake or error and the computing means 5 can be programmed to anticipate and react differently to this type of mistake compared to other incorrect answers. For example, the system can present a specific explanation of this type of wrong answer to the user U facing an addition of a negative number problem. In addition, other dynamically generated examples of solving this type of (addition of a negative number) problem can be presented to the user U followed by the computer/software-selection and presentation of appropriate question sets.

In addition to number questions, presented questions may take other forms. Questions may also be presented as letters (e.g., to copy), words (e.g., to define), formulas (e.g., to classify), diagrams (e.g., to define as an electrical network), icons or symbols (e.g., to select as representing specific processing concepts), allegories (e.g., to identify as representing types of human characteristics), essay questions (e.g., to illustrate a readability index), graphs, tables or other types of presentations to the operator U.

In addition to questions, device auto-generation of tips or other clues may be included in a system presentation or response to the user U. For example, simple question sets are presented with questions such as 5+6=, 3+7=, and 8×5=. These are problems whose answers ought to be memorized and math tips may help the operator memorize these answers. For example, assume the operator is working on adding 5's. The math facts associated with adding 5's are 5+1=6, 5+2=7, 5+3=8, etc. Based at least in part on the upcoming question mode and complexity, appropriate tips for the student to study and memorize can be presented before the next question set or worksheet is presented, e.g., showing the answers to 5+n=? for n=1 through 9 before presenting a 6+n=question in the next set of problems.

As used herein, a topic (of a problem or problem set) is defined as a function of the subject matter and/or the type intellectual steps needed solve the problem. Examples of topics include multiplying integers, multiplying fractions, integer addition, quadratic equations, decimal subtraction, variable substitution, divisibility rules, factoring, statistics, unit cost, placement of nouns in a sentence, definition of adverbs, tenses of a regular or irregular verb, and other English language skills especially where memory is required, translation of single foreign words into English, foreign words requiring a male article, foreign idioms, and other foreign language skills especially where memory is required, formulas for various hydrocarbons, elements of the periodic table, properties of salts, metals, and other chemistry skills especially where memory is required, event dates, event locations, and other history skills especially where memory is required, city names, bodies of water, states, and other geography skills especially where memory is required, strength of materials, electrical conductivity or dielectric strength of materials, corrosion resistance, and other engineering skills especially where memory is required.

As used herein, a milestone level is associated with a question set and is defined in terms of the computer-selected performance parameters and operator performance measures, e.g., as related to problem difficulty and operator's competence responding at the milestone level's problem difficulty. Completing higher milestone levels represent an increasing level of competence within a topic or subtopic being learned about. There are typically at least two measured operator performance components of a competence or milestone level within a topic, e.g., correctly answering questions at a given complexity and within a selected response time. Other milestone level components may include correctly answering questions at a particular mode, correctly answering a question within a time limit for the question, the number of questions in a set of questions that were answered correctly, and a minimum portion of correct responses to a set of questions.

Still other performance components of a milestone level may also include some of the other mental functions required to solve the set of problems, e.g., see The Nature of Human Intelligence, J. F. Guilford, McGraw-Hill, 1967 (e.g., see pages 60 to 67) where many different human cognitive abilities are described in three categories or dimensions: operations; content; and products. An example of other mental functions required to solve a problem that may not be included in a given complexity or other performance measures of difficulty is a problem of adding two numbers and translating a resulting “-teen” number (e.g., the numbers 13-19) into another language may have a different milestone rating than adding, then translating other two digit numbers (e.g., the numbers 20-99) even though the type of mental steps needed and the number of mental steps needed (in the topic and complexity in this example) may be considered the same.

Each competence or milestone level may have a milestone rating value and any increases from a lower competence within a topic may represent non-linear learning progress towards greater competence in understanding the topic. For example, the first milestone level for a specific topic and mode would have a rating a zero, but may have a non-zero rating. The second milestone rating of the second milestone level would typically have a higher rating, typically not the level number 2. In one example, the general goal of a student is to reach a milestone rating of 100 within a topic or subtopic, representing that the student is proficient within that topic or subtopic. Not all milestone levels must have an associated milestone rating and milestone ratings of more than 100 may also be achieved representing advanced competence by that the student or other user within a topic or subtopic. The number of milestone levels and any associated milestone ratings that are present within a topic can vary although one of the milestone levels is typically expected to have a milestone rating of 100.

As used herein for most examples, the complexity of a problem is defined as a function of the number of steps needed to solve a problem within a topic or subtopic, optionally having one or more modes at a specific complexity. However, one type of problem set or a single nature of a problem set may have more than one measure of complexity. Another embodiment may express complexity as a measure of difficulty as measured by the length of the shortest computer program (or number of steps) that generates answers to all of the problems within a given complexity. For example, adding two numbers having two digits may be at a first complexity while adding two number having four digits may be at another complexity since additional steps are needed to solve four-digit number questions. Similarly, multiplying two or four digit fractions may be at different complexities within the same mathematics topic. As applied to reading comprehension, the complexity of problems may be based on word frequency, word or sentence length (e.g., number of words in a sentence), or the number of syllables in a new word.

As used herein, a mode of a problem or set of problems is defined as a function of an optional restriction that limits the range of possible problems within a topic, subtopic, and/or given complexity. Problems within a mode will typically have the same number of intellectual steps and complexity, but have a relationship to each other beyond being at the same complexity within the same topic or subset of a topic. For example, if a set of simple addition problems has a complexity=7 and no mode is specified, problems like 1+1, 1+2, . . . 3+5, . . . 6+7, 7+7 with no operand greater than 7 will be presented. But if at a complexity=7, the mode is set at 3 (i.e., mode=3), all problems in the set would include a 3, such as 3+1, 3+2, 3+3, 3+4, 3+5, 3+6, 3+7, but NOT 3+8. Thus, the mode restricts the range of problems that are possible at complexity of 7.

Specifically defining an optional mode generally varies from one topic to the next. For example, a mode for simple addition problems may restrict simple addition problems to a specific subset of problems, such as problems restricted to 5+something, or 6+something, or 7+something. In contrast, multiplying integers and multiply fractions are typically topics that have different modes from simple addition, e.g., a mode within a fraction problem topic precludes fraction problems having simple fractions or mixed fractions or improper fractions. Another example of different modes would be arithmetic problems limited to seeking only the mean, median, or average statistical values. Subset modes within these 3 statistical problem sets could include problems limited to having simple lists of numbers, having bar graphs, and having tabular data. Other examples of different modes (as a restrictive component of achieving a mathematics milestone level and associated rating) include: limiting problems to exclude negative numbers, limiting the answers to real numbers within a topic of long division, limiting a multiplying fractions topic to a mode having all quarter fraction multiplications, restricting missing factor problems to either fill in the blank or algebra, allowing missing operator problems to use addition/subtraction or addition/subtraction/multiplication/division, setting graph-reading problems to positive numbers or positive and negative numbers, setting the maximum number of sides in a polygon for various geometry problems, restricting fraction addition problems to always have common denominators, and setting linear equations to certain formulas like y=m×+b and ax+by =c.

Similarly for other topics, answering multiple choice questions (with one choice being the correct answer) may be a different mode than answering similar questions without multiple choice answers or answering other types of multiple choice questions potentially having two correct answers requiring the answer to be the one that is more correct than the other. If a mode is used as applied to reading comprehension, a reading mode may be defined as limiting new words presented to the user, e.g., limiting new words to those having a type of similarity to previously understood concepts or words. As applied to language studies, examples of different optional modes could include limiting translation problems to only individual words, short idioms, and/or simple sentences. Another mode could limit translation problems to words having a common root. Applied to typing skills, different modes may include lowercase letters, mixed case, alphanumeric, and symbols. Applied to geography, modes may restrict concepts to just country names, just capitals, just demographic information, etc.

The preferred means for computing 5 is a computer that stores complexity and other parameters of a problem set (e.g., mode, time limits, and number of problems) within a topic and also stores operator performance measures such as the operator's actual time to solve questions and the number of problems solved correctly. The computer 5 provides a memory means for a storing one or more request data sets and algorithms to selecting system responses. The request data sets and algorithms are capable of generating a plurality of requests for a response by an operator and further including corresponding response data sets and algorithms related to the appropriateness of the operator responses. The computer 5 allows at least some request data sets and algorithms to reflect different values of intellectual complexity with respect to other data sets and algorithms within a plurality of request data sets and algorithms for each topic.

In one embodiment, an operator's performance measures are detected by the learning system 2 and processed by the computer 5, e.g. having an algorithm comparing current performance measures against past operator performance measures in conjunction with one or more algorithms that select an appropriate system response (based at least in part on the comparison) in the form of electronic signals to be transmitted to the means for presenting 4. Alternatively, the means for computing 5 may transmit hydraulic/pneumatic signals, mechanical signals, optical signals, aural signals, or other signals transduced by alternative presentation means 4. Signal processing by the computer means 5 may include algorithms or other software that randomly generates problems within a mode and/or complexity, compares an operator answer to a correct answer, compares an incorrect operator response to types of erroneous responses, calculates response times for a series or set of questions, and selects a type of system response based at least in part on input signals indicative of past performance measures and compares past performance measures to benchmarks or other standards.

One embodiment of the inventive learning process for at least one operator using an inventive learning device comprises 1) communicating a first set of questions on a topic to an operator wherein the time limit to answer the questions, the number of questions and the mode and complexity of the questions are selected to be within a mode from among a plurality of modes and within a complexity from a plurality of complexities, and within a milestone level, 2) the operator responding with a first response to the first set of computer-selected questions wherein said operator's response includes the measurement of at least one operator performance measure in addition to the correctness of answers to questions posed by the first response, 3) communicating a second set of questions from the learning device to the operator wherein the selections from among ranges of the number of questions, time limits, modes, complexities, and milestone levels of the second set of questions are based at least in part on said one or more operator measures in addition to the correctness of the answers in said first response, 4) operator responding with a second response to the second set of questions, and 5) quantifying any milestone rating improvement or other learning benefit that the operator receives from the process.

In addition to the complexities (and optional modes) discussed above, the process embodiment employs a concept of milestone levels that quantify a competence of performance and/or effort required to complete and the associated learning performance within a topic. From differences in milestone levels (e.g., related to different sets of questions) over using time, the learning benefit of using the process can be measured. In addition, the milestone level data can be used to guide the presentation of further problem sets requiring an amount of effort that will appropriately challenge the operator who has achieved a given milestone level.

As used herein, the amount of effort is defined as a quantified measure of time expended by a user and/or other measure of effort by the user in answering questions within a mathematical or other topic. For example, after a period of use of the inventive process, an activity summary for a student or other operator can be prepared that includes performance measures and indicates an amount of effort. The activity summary may include an effort/performance measure value called Time Spent, which is one preferred measure of amount of effort. Time Spent is defined in this example as the sum of all of the recorded time periods when the operator was working on timed worksheets within a milestone level, a series of milestone levels, or within a topic. In an alternative embodiment, Time Spent may be only the time spent by an operator on a mode within a given complexity. Time Spent is an effort/performance measure that can also be used to indicate the total amount of effort expended by a student or other operator on several problem sets. This effort/performance measure can be used to reward students expending substantial efforts or their best effort over a period of time or expending among the best efforts in a class, independent of the milestone levels achieved by the operator or other indications of learning progress.

Time spent however, preferably does not include idle time, e.g., an excessive amount of inactive time when a student did not have any activity during a timed set of questions. For example, idle time could be counted for periods of inactivity lasting, 1, 2, 3, or more minutes during a timed period for responding to a set of questions. Idle Time may be a negative performance measure in a reverse sense of Time Spent. In another example, idle time is a measure of long gaps of time between timed worksheets, e.g., 2, 3, 5, or more minutes. Each type of idle time may also be separately recorded or combined with another measure of idle time. Idle time may also include other time periods, e.g., long gaps of time between answering one question and any changes to that answer, but idle time may also exclude other times when the user is logged onto the system, e.g., reward time or other time excluded from the calculation of idle time by a third party such as a teacher.

To better understand the various types of process logic that can be programmed in computer 3, some definitions of parameters, algorithms, and examples are provided:
Current Milestone: The milestone level that the user has already achieved. For example, when a user does a topic for the first time, the user's current milestone level is typically level 0 until the user successfully completes the requirements for a milestone level within the topic.
Next Milestone: Defines the parameters of the next milestone level. Conceptually, the next milestone level should be significantly more difficult or challenging than the current milestone level. For example, if at milestone level 0 the final complexity is 5, the next milestone level (level 1) may have a higher complexity, such as 7 or more.
wasAccurate: A Boolean function that describes if the user was nearly or fully accurate on the last worksheet the user finished. In this example, accuracy is based on the number of problems successfully completed by the user over the total attempted, not the total number of problems in a set available. For example, if a worksheet or set of problems has 10 problems but the user attempted 9 of them, then accuracy is based on accuracy of the 9 problems attempted. The specific parameters for this example are as follows:
   If the number of attempted problems is less than 4, the user must answer all of the problems correctly in order to get wasAccurate=yes.
   If the number of attempted problems is at least 4 but less than 8, the user must answer 85% of them correctly to get wasAccurate=yes.
   If the number of attempted problems is 8 or greater, the user must answer 75% of them correctly to get wasAccurate=yes.

The general purpose of the wasAccurate term is to determine if the complexity should decrease in the event that the user failed to correctly answer get all questions assigned (100%). If the user failed to score 100%, but wasAccurate=true, the complexity does not decrease. However, if wasAccurate=false, the worksheet problems are concluded to be too difficult, so the complexity of the next set is reduced.
isBelowExpectations: A Boolean function that describes if the user is currently performing below expectations. If the user performs poorly on a worksheet such that the next worksheet is to be easier, and if the current parameters are equal to or less than the current level, then isBelowExpectations=true.
isOnVergeOfNextMilestone: A Boolean function that describes if the user will reach the next milestone provided that he scores 100% on the current worksheet. If all parameters (e.g., number of problems, complexity, mode, and time limit) are equal to the next milestone's parameters, then isOnVergeOfNextMilestone=true.
complexityLeft: The difference between the next milestone level's complexity and the current worksheet's complexity, not to be confused with the current level's initial complexity.

getMinProblems: A function that returns the minimum number of problems to appear on a worksheet. The minimum number of problems is the larger of the current level's number of problems and the next level's number of problems, multiplied by 0.8. This exists to prevent a worksheet from having too few problems in the event of reduced worksheet difficulty.

TABLE 1
Adaptation Example Scenarios

| Milestone | | | Time Limit | | |
|---|---|---|---|---|---|
| Level | Complexity | # Problems | (sec) | Mode | Rating |
| 0 | 9 | 10 | 40 | 1 | 0 |
| 1 | 9 | 10 | 45 | 2 | 5 |
| 2 | 9 | 15 | 45 | 2 | 10 |
| 3 | 9 | 10 | 45 | 3 | 15 |
| 4 | 9 | 15 | 45 | 3 | 20 |
| 5 | 9 | 10 | 45 | 4 | 25 |
| 6 | 9 | 15 | 45 | 4 | 30 |
| 7 | 9 | 10 | 45 | 5 | 35 |
| 8 | 9 | 15 | 45 | 5 | 40 |
| 9 | 9 | 10 | 45 | 6 | 45 |
| 10 | 9 | 15 | 45 | 6 | 50 |
| 11 | 9 | 10 | 45 | 7 | 55 |
| 12 | 9 | 15 | 45 | 7 | 60 |
| 13 | 9 | 10 | 45 | 8 | 65 |
| 14 | 9 | 15 | 45 | 8 | 70 |
| 15 | 9 | 10 | 45 | 9 | 75 |
| 16 | 9 | 15 | 45 | 9 | 80 |
| 17 | 10 | 20 | 60 | 10 | 85 |
| 18 | 10 | 30 | 80 | | 90 |
| 19 | 10 | 50 | 130 | | 100 |
| 20 | 12 | 50 | 80 | | 105 |
| 21 | 15 | 50 | 60 | | 110 |

The following example will reference the process-adaptation scenario chart shown in Table 1. Four parameters of a question set at each milestone level are shown along with the assigned milestone ratings. References to the four question parameters in this example will referred to in the following discussion in the following order within squared brackets: [complexity, number of problems in a set, time limit to answer the problems, mode]
When User Gets 100% on a Worksheet or Set of Problems . . .
1. If User is on Verge of Next Milestone level
User has reached the next milestone level. Update rating to reflect new milestone level. For example, if the thirteenth milestone is current and [9,15,45,8] includes the current question parameters (with the user getting 100% correct), then the fourteenth level is the new milestone level with a milestone rating of 70. CurrentMilestone becomes 14 and NextMilestone is 15. Successive worksheets or sets of problems may have a harder complexity and/or number of problems and/or time limit and/or mode.
   2. Make Next Worksheet Harder
   Increase Complexity
   If current complexity is less than next milestone level's complexity, increase complexity using these steps:
Determine the milestone gap, which is the next level's initial complexity-current level's initial complexity, and is an initial range of acceptable complexity values. For example, if the user is on the twentieth milestone level going to twenty-first level, the milestone gap from Table 1 is complexity 15−complexity 12=3.
If (milestone gap<10), increment=([complexityLeft+6]/5), rounded down, but at least equal to 1.
If (milestone gap>=10), increment=milestone gap/5, rounded down, where increment is defined as the amount that will be incremented in complexity for the next worksheet.
timeRatio=time spent on worksheet/time limit
If timeRatio is less than 0.3, user was very fast, e.g., the complexity was not sufficiently challenging. Increment current complexity by (increment×5)
If timeRatio is 0.3 to less than 0.5, increase complexity by (increment×3)
If timeRatio is 0.5 to less than 0.8, increase complexity by (increment×2)
Otherwise, increase complexity by increment
   Example: Currently on the eighteenth milestone level, on verge of the nineteenth level 19, a user scored 100% of the question set correctly in 125 seconds.
User increases current milestone level to 19
Milestone gap is 2 (complexity 12−10)
increment=([6+2]/5), rounded down=1
timeRatio=125/130=0.96
New complexity=10+increment=10+1=11
If current complexity is greater than next complexity, reduce current complexity to next complexity.
   Increase Number of Problems
   If the current number of problems in a worksheet or set is less than the next milestone's number of problems, the system increases the number of problems by following these rules:
problemSpeed=number of problems completed divided by the number of seconds used.
Multiply the next milestone level's time limit by the problemSpeed and round up. This gives the number of problems for the next worksheet or set of problems.
If calculated number of new problems is the same as before, increment number of new problems by 1.
If the new number of problems exceeds the next milestone level's number of problems, reduce number of problems to equal next level's number of problems.
   Example: Current milestone level=7, user got 10 right in 40 seconds
problemSpeed=10/40=0.25
45 seconds*0.25 problems/second=11.25 problems. Round up to 12.
Next worksheet will have 12 problems
   When User Scores Less than 100% on a Worksheet . . .
   1. If User is BelowExpectations (BelowExpections=True)
   Keep track of how many times in a row this occurs. If this is the 3^{rd} time in a row and current milestone level is greater than 0, reduce the current level to the previous level and reset all worksheet settings to the previous level.
   2a. If wasAccurate=Yes
   Complexity stays the same.
   Set the number of problems to be the larger of the number of problems attempted and getMinProblems.
   2b. If wasAccurate=No
   Calculate ⅕^{th} of the difference in complexities between the current level and the next level=decrement which is the reverse of increment. Decrease or decrement the next worksheet's complexity to this amount.
   Reduce the number of problems to the largest of:
number of attempted problems*0.7
number of attempted problems*accuracy percentage
getMinProblems

In another process example, if the user is new to a topic but previously had acceptable performance, the computer is programmed to give the user a chance to do a set of problems at a middle milestone level (e.g., rating ˜50) rather than at the lowest level or entry level. However, the user does not get credit for the associated middle milestone level rating until and unless the user gets 100% of a worksheet or problem set at that level. Alternatively, the device can be programmed to also have some tolerance, e.g., to give the user several tries at achieving the 100% performance at the middle milestone level.

In another process example, a file, topics.xml, contains most or all of the supported topic's name, description, and milestone level settings. In this example, the user starts a new set of problems at a milestone level starting at level 0, but the device is programmed to allow the user to skip entire complexities and/or milestone ratings if one or more performance measures so indicate. One method of accomplishing this is to add a new optional parameter call skip to the levels in topics.xml. As an example, if skip=2 when the user is very fast, we skip 2 levels. This results in the user getting credit for jumping to level 2 from level 0 and is on the verge of passing level 3. If the user was accurate but only somewhat fast, skip=1 and the milestone level is advanced by one level. Defining and/or identifying where to add skip parameters can be changed for different application or topics.

In still another process example, a new optional parameter is added to milestone ratings and called challenge. If challenge=yes, the user is allowed to select or challenge at that level. If the user gets 100%, the user advances to that milestone level. For example, a Fast Addition topic (in topics.xml) has a milestone rating of 90 and tests fast addition through 9+9. If the challenge parameter is set=yes, the user can simply challenge that milestone rating and, assuming the user achieves 100%, the user would get credit for that milestone rating and level. If two different milestone levels have challenge parameters, the user can typically only challenge the lowest challengeable level the user has not yet passed.

In addition to the specific process examples provided above, the process generally sets learning performance variables that challenge the operator in the next set of problems presented to the operator. Although the computing means 5 can be programmed to base the selection of the performance variables of the next set of questions on two operator performance measures, a more complex selection process using many more operator performance measures, variables, and relationships is preferred for many learning topics.

For example, quick and correct completion of some questions in a set of questions (based on the parameters of complexity and time limit along with the related measures of time to complete and correctness of the operator's answers) can lead to a following question set that meets the criteria of the next milestone level (such as having a higher milestone rating, increased level or degree of complexity, increased number of questions to be answered, and/or a decreased time to answer), as well as leading to presentations that supplement or replace a new set of questions with other non-question presentations such as performance rewards, e.g., presenting a game diversion, achievement certificates, or other operator-desired presentations or interactions.

Reaching the next milestone level generally implies competence at that level and includes an expectation that the operator will be able to sustain that milestone level of performance (and any associated milestone rating) if retested within a short period. In other words, it would be unusual to reach a milestone level then consistently fail to satisfy that level if retested within about a day or two after achieving the milestone level. It is also expected to be unusual for an operator U to reach a milestone level then consistently fail to satisfy that level after a short review and an intermediate period of time, e.g., a short review being provided if the operator has not been using the learning device for periods of time ranging from about one to three weeks. For periods of time longer than about one to three weeks in this example, the operator is expected to avoid failing to satisfy that milestone level after the learning device presents a more comprehensive review.

Consistently failing more than one milestone level previously accomplished for a topic (possibly with a review) may not only drop down the milestone levels in follow-on problem sets presented within a few days or less from the prior set of problems, but also possibly imply that a different operator may have been using the system. Such an event can therefore suggest cheating, e.g., where a more competent operator previously artificially boosted another operator's performance to a milestone level beyond his or her competency. In this type of event, notification to someone other than the operator (e.g., requesting the other person to further question the operator) may be part of the response of the device 2 to these types of changes in operator performance measures.

In general, one objective in the process of device-selecting the milestone level of the next set of questions presented to the operator is to create a milestone performance level that is challenging, but also a milestone that can be readily reached by that operator. The learning readily-reached ability of an operator is essentially evaluated and measured by the plurality of performance measures during responses to device presentations. Consistently meeting this readily-within-reach objective avoids much frustration, generates confidence in the operator's learning abilities, and allows more competition between operators where the question sets (or learning playing fields) can be individually or group adjusted to maximize learning progress. In another way of expressing this objective, keeping the challenge of the set of problems close to the operator's capabilities can act as a game environment with part of the rewards of using the learning system being the satisfaction of consistently beating the parameters set by the system and/or beating other students, e.g., beating the time limit, beating a previous best time, answering most or all questions correctly, and/or advancing to the next milestone level or complexity value faster than other students and/or increasing in level faster than was previously accomplished.

Meeting this within-reach challenge objective is accomplished using milestone level, complexity and related parameter changing algorithms. The algorithms preferably use Boolean logic comparing measured performance values (or values based at least in part on measured performance values) with specific standards using true or false gates. The Boolean logic may also use statistical functions, e.g., when a measured performance parameters is 3 standard deviations from normal, a notice is sent to a third party such as a teacher. However, other types of artificial intelligence approaches can be used such as fuzzy logic algorithms, e.g., measuring the degree of “good” operator performance on one set of questions and adjusting the parameters of the next set of questions based on the degree of “good” or “goodness.” If fuzzy logic is used, it would typically also require functional definitions, e.g., defining the function of degrees of “goodness” as an “S” curve between one performance point (e.g., immediately getting all questions correct or perfectly “good” performance) and another performance point, e.g., getting none of the questions correct within the time limit or perfectly “poor” performance. In addition, the algorithms used may also be subjectively modified, e.g., a teacher may understand that a particular student needs the next set of questions to be much harder than normal in order to keep that student's interest or that outside teaching assistance is needed more quickly for different student when compared to most other students.

To better understand milestone levels and the process of selecting milestones in general terms, consider an example of a milestone-adaptation algorithm with two or more factors affecting milestone level adaptation. For this example, let there be three factors and three related performance measures within a topic: problem complexity (and a related performance measure of whether problems are answered correctly), number of problems presented (and a related performance measure of how many questions are answered), and a time limit (and a performance measure of how many questions are answered correctly within the time limit). Suppose an operator correctly finishes a set of questions with “N” questions at complexity “C” within time limit “T.” Increasing the required N or C, or decreasing T would make the next worksheet harder, but not necessarily change the mode, change the topic, or alter the basic concepts needed to solve the questions. For some types of problems (with some variable factors combined with some performance measures), it may make sense to program the device to simply increase the number of problems presented to the operator with a given time to answer because the speed of recognizing the type of problem can be a good indication that the concept is well understood by the operator. In other cases, the complexity of the problem may be increased or the time given to solve the same number of problems may be reduced, e.g., where excessive repetition could be boring to an operator.

A milestone rating within a topic may also quantify a level of achievement within the topic. For example, in an educational setting, the rating for each topic can be used to assign grades in a fair and equitable manner. For example, a rating of 100 may mean the student user is proficient with respect to a state educational standard for the topic. The rating can also be used to measure relative improvement of an operator over time. For example, if a student was at a milestone rating of 20, but in his or her next use or lab session, raised this student's milestone rating to 60, the increase in rating suggests an improvement in proficiency.

The milestone ratings do not have to be equally spaced. For example, going from a first milestone level to a second level may be relatively easy, but going from the second level to the third level can be hard for an average operator. Applying a rating to each level that reflects these differences can make the operator's progress (to attaining a proficiency in the topic) easier to ascertain. For example, using a rating range of from 0 to 100 (with 100 meaning proficient) with various intermediate milestones ratings placed at milestone levels that are appropriate measures of progress to a proficiency in the topic. Milestone ratings may be given to some portion and varying numbers of milestone levels and also exceed 100, e.g., to indicate advanced proficiency. The advanced and intermediate ratings at various milestone levels may make it easier to quantify operator performance for different types of problems within a topic. For example, reaching a fifth milestone level for addition questions within a topic might be worth a score of 100, but reaching a fifth level for multiplication questions might be worth 50. The milestone ratings or scores may also provide guidance to the operator U or others with access to the ratings, e.g., guiding which types of questions should receive the most work using the learning device.

In a preferred embodiment for a Fast Addition topic, there are 21 rating levels, e.g., level 19 having a milestone rating of (or being worth) 100 and level 21 being worth 110. The reason this number of rating levels is preferred is that many milestone levels have modes in this topic that restrict the problems to concentrate on particular subsets of memorization. For example, milestone rating level 7 restricts the problems to all be 5+something. The Fast Subtraction topic, on the other hand, does not have any modes that further restrict problems to a special set of numbers within a given complexity. Thus, the preferred Fast Subtraction topic has only 6 milestone levels, with level 4 being worth 100 and level 6 being worth a 110 milestone rating.

Whereas the Fast Addition topic guides the user through 1's through 9's using optional modes, modes are typically not necessary for subtraction at certain grade levels, so less milestone levels are preferred. The preferred objective is to provide enough rating levels of varying difficulty and possibly different modes to give the student user and/or teacher confidence that successive levels are within reach and when the user reaches a milestone rating of 100, he or she really understands the topic. Due to the uniqueness of each math topic, the number of milestone levels and any associated optional modes can vary considerably.

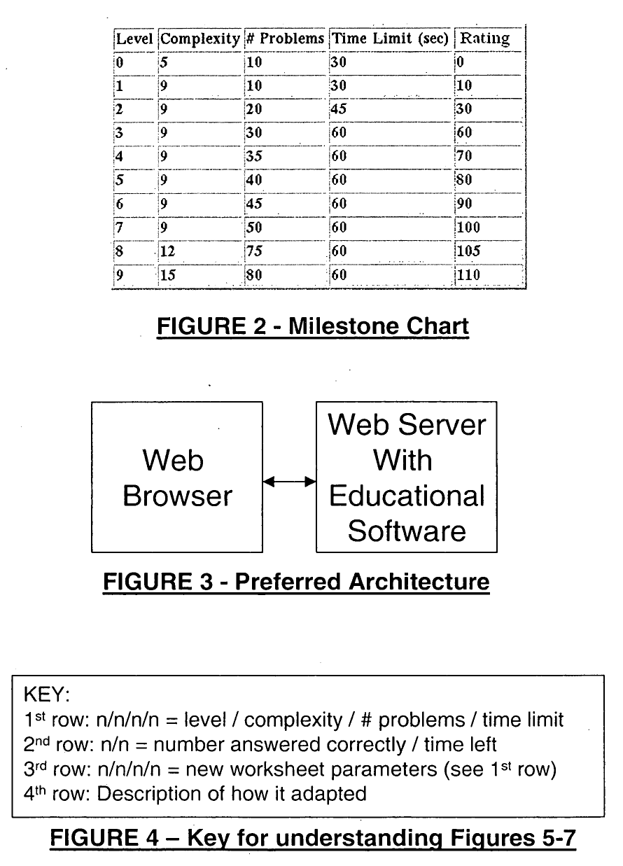

FIG. 2 is a milestone chart showing milestone level settings for various milestone scores or ratings including the milestone components of complexities and modes. The nature or type of the problems presented to the operator is not critical to the milestone concept, but in this example, the problems represent sets of questions or worksheets having a group of simple addition problems. In this example, complexity is measured as the maximum operand such that at complexity 5, the problems would range from 1+1 to 5+5, while at complexity 9, the questions would range from 1+1 to 9+9 and so forth. In this example, the number of problems in a set of problems and the maximum time limit, in seconds, the operator is allowed to answer the problem set are combined with the complexity measure to determine the milestone level. However, any number of different performance measures or factors can be used in other instances to determine a milestone rating. The milestone rating quantifies the magnitude of the operator's achievement using at least two performance measures and/or factors, preferably at least three, more preferably at least four, and still more preferably at least five for some complex applications.

In other non-math examples, complexities can be measured by the readability of problems or a similar index, the number of letters in audible words presented to be spelled, the number of unknown variables or simultaneous equations/concepts needed to respond with the correct answer, the format of problems presented (e.g., a multiple choice math problem presented in word format or numerical format), and the format of response required (e.g., yes/no, multiple choice, or essay response). The number of problems in a set can be measured not only by counting independent problems, but e.g., dependant problems, component portions of problems, and/or elements of a correct answer. Although time limits are typically measured in seconds and minutes, other time limits may include measurements in heartbeats, eye blinks or movements, breaths, head motions, and pupil dilation/contractions.

The milestone chart shown in FIG. 2 can be referred to for most of the method embodiment examples illustrated in FIGS. 3-7 and discussed hereinafter. For the purpose of these examples, the milestone chart represents milestone levels and optional ratings for simple subtraction problems with two operands. In these examples, complexity stands for the maximum operand value such that at a given complexity n, the most difficult question would be n-n, the number of problems is the number of two-operand questions in a set posed to the operator, and the time limit is the time in seconds for the operator to respond to all problems in the set.

FIG. 3 illustrates a preferred architecture embodiment of this invention employed in a networked environment using an Internet browser for presentation of the system response and operator input interfaces. The Internet browser connects the input and presentation means to the computing means that may be one main computer or a web server. The invention may also be employed in other configurations, e.g., on a single system or device having a computer and appropriate input and output means), a linked group of computers at a single location or a networked or linked group of computers at several locations. In a networked environment, interested persons besides a primary operator could be granted access to portions of the primary operator's answers, questions, and/or other performance measures. These other persons could include teachers, parents, employers, vocational instructors, therapists, and administrators.

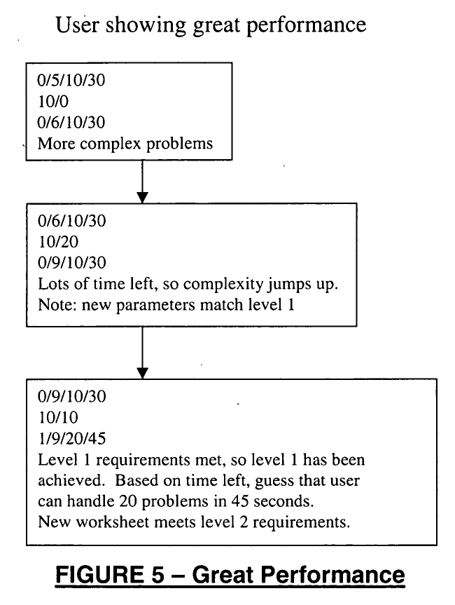

FIG. 4 is a key to be used in conjunction with FIGS. 5-7. The key describes the relevance of the lines/rows in each box or process step shown in FIGS. 5-7.

FIG. 5 is an example of a process embodiment that demonstrates what can happen when an operator quickly finishes problem sets or worksheets correctly along with some of the logic that may be used to determine follow-on presentations to assist in learning by the operator. In the first box of process steps, the inventive system dynamically generates a set of ten random subtraction problems at an initial milestone level (level 0) within a Fast Subtraction topic. The complexity (at milestone level 0) is set equal to 5 and the ten questions are to be answered within a thirty-second time limit. The system then presents the ten-problem set to an operator. In this example, the operator correctly answers all ten problems of subtraction in the first set just within the time limit as shown in the second line of the first box or operator process step, i.e., zero time left. The system, using algorithms, compares these operator performance measures to a set of standards that, if met, the operator is considered ready to handle the next complexity value. The system generates a second set of ten random subtraction problems at complexity=6 to be answered within the same 30 second time limit. The second problem set is then presented to the operator.

Comparing milestone levels 0 and 1, milestone level 1 specifies complexity=9 but milestone level 0 only specifies complexity=5. Because the operator finished the first set of problems (or worksheet) correctly (measure 1) within the time limit but with not much time to spare (measure 2), the system randomly generates the next set of problems within parameters that are instead only a little more challenging by selecting to raise the complexity to an adjacent level.

In the second step (as shown in the second box of FIG. 5), the second set of randomly generated problems (within the constraints of the milestone level) formulated by the inventive system in the first box (and shown in line 1 of the second box) is presented to the operator with the same time limit. In response, the operator rapidly and correctly answers all ten questions with 20 seconds to spare as shown in line 2 of the second box. The system compares the combination of these two operator performance measures with standards, the comparison justifying a jump in complexity to the next milestone level for a third set of problems, milestone level 1 initially having a complexity of 9, with ten problems to the set, and a time limit of 30 seconds as shown in line 3 of the second operator step or box as well as in FIG. 2 at milestone level 1. The jump in complexity shown in FIG. 5 minimizes user boredom and is, in essence, a reward for prior great (i.e., accurate and fast for the number of problems presented) performance as measured by at least two operator measures.

Other rewards for good performance may also be presented to the operator, e.g., cash, discount coupons at retail stores, games time, clues to winning games, jokes, entry into the chance to win prizes, certificates of excellence, notification of superior performance to third parties such as parents, and actuating reward sensory devices such as pleasurable electronic impulses or tickling devices. Other responses or presentations to the operator may include, step by step examples of solving problems at a new milestone level, requests to assist slower learning students, operator options to select the next mode and/or complexity to be presented (e.g., the next set to act as a breather period while reviewing the concepts), options to select a desired next time limit and/or the number of questions to be presented, options to select starting time of the next set of questions to be presented, options to select other icons or handles such as a superhero name or a character to represent the operator.

For the example shown in FIG. 5, the variables or parameters for the next set of problems in box 2 now match all of the milestone level 1 criteria. If the operator completes the set correctly, he or she will therefore reach milestone level 1.

In the third step (as shown in the third box of FIG. 5), the operator (in response to the third set of problems) correctly and rapidly answers all ten questions with ten seconds to spare. This elevates the operator to milestone level 1 without incremental presentation of the remaining problem sets at level 0. The system compares the three measures of operator performance (number of answered problems, time to complete, and correctness) with standards that justify a jump to presenting the operator with a set of problems having a complexity of 9, 20 problems to the set, and a time limit of 45 seconds. If answered correctly within the time limit, the operator would be elevated to milestone level 2. Comparing milestone level 2 with level 1, both the time limit and number of problems are different. The system changes the time limit for the next worksheet and also raises the number of problems by calculating the rate at which the operator finished problems in the previous worksheet and extrapolating what he or she is capable of finishing. In this case, the number of problems is set to 20, effectively setting the operator up for a chance to reach milestone level 2. It is important to notice that in this system, the operator does not reach the presented milestone level until he or she has proven that he or she can handle that level (and any corresponding rating) by satisfying its requirements. This makes it unlikely that a user will regress to a previous milestone level with its correspondingly reduced milestone rating.

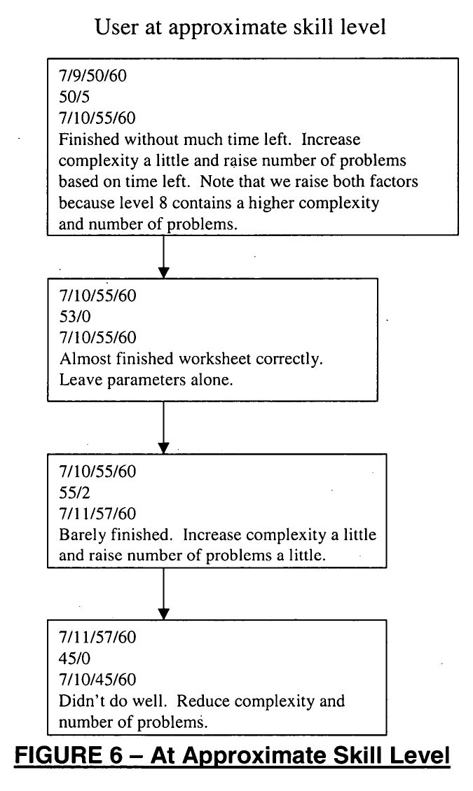

FIG. 6 demonstrates an example of what may happen when an operator has reached a milestone level that he or she cannot readily progress beyond without further work. Comparing the parameters of milestone level 7 with level 8 as shown in FIG. 2, both the complexity and number of problems are different. In the initial operator step at milestone level 7 as shown in box 1, first line of FIG. 6 shows that the operator is presented with a set of 50 problems having complexity 9 and to be completed within a 60 second time limit. On the second line of the initial step or box, the user correctly finishes the set of problems with little time left (i.e., 5 seconds). Based on these performance measures compared to standards for this set of parameters, the inventive software selects a number of problems and complexity modestly increased for the next set of problems presented to the operator as shown in the first box of FIG. 6. In the next step as shown in the second box of FIG. 6, the operator does not quite answer all of the second problem set correctly within the time limit, so the following set of problems has parameters that don't change as shown in the second box of FIG. 6.

This inventive process allows some tolerance for failure, one type of tolerance being illustrated in the step shown in FIG. 6. If the percentage of the problem set or worksheet that the operator answered correctly exceeds a lower threshold dependant upon the number of problems (e.g., 100% for 1-3 problems, 75% for 4-7 problems, and 85% for 8 or more problems), the operator is given another chance at the same settings rather than penalizing the operator by regressing, e.g., presenting a regressive set of problems having a lower complexity.

In the third operator step shown in FIG. 6, the operator correctly finishes the third set of randomly generated problems (with the same settings as the second step), but with little time to spare. Because of this operator's current performance and past performance measures with a series of problem sets, the system presents the next problem set having a complexity and number of problems within a time limit once again increased, but slightly.

In the fourth operator step or box shown in FIG. 6, the operator performs poorly, missing many problems. By comparing the performance measures and possibly past performance to standards, the most likely reason may be concluded to be the increased complexity, especially if the elapsed time from prior operator log-on is longer than a few weeks. The system then selects to present fewer problems at a reduced complexity as shown in the fourth box of FIG. 6.

As an alternative to presenting questions having a lower complexity, the system may replace or supplement this response by presenting clues, hints, examples, partial answers, or suggestions on how to solve problems at comparable modes and/or complexities. Note that in the event that the operator only attempts 45 of the problems and gets all or nearly all of them right, the system could react by reducing the number of problems but not the complexity. This reaction could be based on high accuracy (e.g., such as 75% correct for 1 to 7 problems and 85% correct for 8 or more problems), but slow performance. For example, if there are 50 problems, and the operator only answers 45 problems within the time limit but gets 100% of the 45 answers correct, the system may reduce the number of problems, but not the complexity. This example again shows the adaptability and reduced rigidity of the system, allowing individual operators to receive added time and practice when needed. At least as importantly, the system minimizes frustration while presenting sets of problems that are within reach but still challenging, e.g., allowing timed competition among users at different complexities.

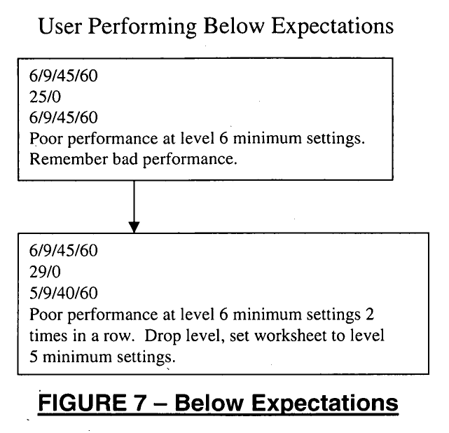

FIG. 7 shows an example of poor operator performance as measured by performance measurement responses that would drop a milestone level. A first set of 45 problems (at milestone level 6, complexity 9, and a time limit of 60 seconds as also shown in FIG. 2) is presented to the operator at the first step or box of FIG. 7 with the operator only answering 25 of the questions. In this example, the system is set to respond to this comparatively poor level of performance measures by this operator (but having prior average performance measures) and treat the poor performance (based on at the current performance measures) on the first problem set as a fluke or unrepresentative of typical performance. The inventive system again presents a generated set of questions having the same milestone, question complexity, number of questions, and time limits. This example again shows the adaptability and reduced rigidity of the system, allowing system presentations to be tailored to various individuals having different abilities as well as a single individual having performance variations, e.g., caused by a distracting environment, illness, lack of competition, and other disincentives at a particular time.

However, as shown in the second operator step or box in FIG. 7, operator performance is again poor based on a plurality of performance measures. The system compares the current pair of poor performance measures and past average performance measures. Based on the comparison, the system essentially assumes that the operator cannot handle the previous milestone level at this time, so the next set of problems presented is at lower milestone level of 5. This example again shows the adaptability and reduced rigidity of the system, allowing individual operators to repeat questions at a reduced milestone level when truly needed to assure learning, but not necessarily at a reduced complexity, question quantity, and/or time limits.

In an alternative embodiment, the inventive system may also be used to test operator groups. For example, this could take the form of providing identical problem sets in a classroom to be completed in the same time limit. It may also take the form of similar problem sets to be completed within similar time limits (where each problem set is randomly generated at the same milestone level by the computer), dropping or using different performance measures (e.g., extending time limits) for classroom tests, or importing standardized tests from third party sources. In addition, the inventive device could generate test grades, e.g., based solely on the correctness of operator answers and/or in combination with other performance measures.

Still further, the inventive process may be simultaneously used by many operators with or without Internet connections, e.g., with a computer means located in a central location being connected to various operator input and response means using wired connections, a wireless network, or other connectivity means. Moreover, a single computer at a central location could act as a learning aid for different operators each learning different subjects. In another embodiment, operators would have the option of selecting or sampling significantly advanced topics and/or complexities in order to understand what may eventually be coming.

Further advantages of the invention are expected to include the flexibility and adaptability to improve operator learning of widely different problem areas for operators having widely different educational achievement, age, experience, and/or intelligence. Examples of widely different areas of learning include: elementary, intermediate, high school, and college subjects and courses: vocabulary building, speed reading & comprehension for children and/or adults; medical doctor and other professional review and/or training; and test taking skills. It is expected that the improved learning using the inventive learning aid process can be shown by standardized performance testing in the subject area when compared to the performance of similar operators using current learning aid systems or using classroom methods without the use of learning aid systems.

Although preferred embodiments of the invention have been shown and described and some alternative embodiments have also been shown and/or described, not all alternative embodiments and similar or equivalent apparatus, functions, and/or means for performing functions of the invention have been shown or described. Further changes and modifications may be made to the invention by those skilled in the art without departing from the spirit and scope of the invention, e.g., to adapt the invention to other applications or constraints.

As used in the following claims, the terms “comprises”, “comprising”, or any other variation thereof, are intended to cover a non-exclusive inclusion of items, such that a process, method, article, or apparatus that comprises a list of elements does not include only those elements but may include other elements not expressly listed or inherent to such process, method, article, or apparatus. Further, no element described in this specification is required for the practice of the invention as claimed unless expressly described as “essential” or “critical.”

While the preferred embodiment of the invention has been described, modifications can be made and other embodiments may be devised without departing from the spirit of the invention and the scope of the appended claims.

What is claimed is:

1. A learning process for an operator operating an interactive learning system comprising a computer, an operator means for inputting to said computer, and a means for presenting information from said computer to said operator wherein said means for presenting and said operator means for inputting are operably connected to said computer, said learning process comprising the following operator steps:
first inputting to said learning system wherein at least two performance measures associated with said first inputting by said operator are measured, wherein one of said performance measures is related at least in part to the amount of time required by the operator to complete at least a portion of said first inputting; and
in response to a computer-selected presentation from said learning system, second inputting by said operator wherein said presentation comprises one or more randomly generated questions within a complexity and a time limit for responding to said questions, wherein said complexity and said time limit are selected based at least in part on said performance measures measured in said first inputting step, and wherein at least two performance measures associated with said second inputting by said operator are measured.

2. The learning process as claimed in claim 1 wherein said presentation also comprises a computer-selected quantity of randomly generated questions within a topic and wherein said selected quantity is also based at least in part on one or more of said performance measures associated with said first inputting, wherein said complexity is selected from a range of different complexity values, and said process also comprises the step of receiving a performance rating from said learning system, said performance rating based at least in part on said operator performance measures associated with said second inputting by said operator.

3. The learning process as claimed in claim 2 wherein said performance measures associated with said second inputting comprise a first quantity portion of questions answered correctly and a time required by the operator to answer a second quantity of questions.

4. The learning process as claimed in claim 3 wherein said performance measures associated with said second inputting also comprise a difference between the fraction of questions answered correctly divided by the total quantity of questions and a reference fraction of correctly answered questions.

5. The learning process as claimed in claim 4 wherein said performance measures associated with said second inputting also comprise a difference in time between said time limit and said time required by the operator to answer said second quantity of questions.

6. The learning process as claimed in claim 5 wherein said performance measures associated with said second inputting also comprise idle time.

7. The learning process as claimed in claim 6 wherein said performance measures associated with said second inputting comprise an elapsed time from a prior use of said interactive learning system.

8. The learning process as claimed in claim 7 wherein said performance rating is based said operator successfully answering at least a portion of a set of questions having a rating-associated complexity, a rating-associated quantity of questions to be answered, and a rating-associated maximum time required to answer said quantity of questions.

9. The learning process as claimed in claim 8 wherein said complexity of said set of questions is calculated using a level adaptation algorithm wherein said algorithm uses fuzzy logic.

10. The learning process as claimed in claim 9 wherein said set of questions within said complexity is further restricted to those within one mode.

11. The learning process as claimed in claim 10 wherein one performance measure is a quantity of any erroneous responses to said set of questions wherein said erroneous responses are within one or more types of erroneous responses.

12. The learning process as claimed in claim 11 wherein said presentation associated with said second inputting also comprises at least one of the following: a clue for answering a question; a sample answer; a hint on how to answer a question; a partial answer; a suggestion on one way to answer a question; a cash coupon; a discount coupon at retail stores; time off for said operator to play a game; a clue to winning a game; a joke; a chance to win prizes; certificates of excellence; notification of above expected performance to third parties; actuating a reward sensory device; a request to assist slower learning students; operator options for new questions to be presented having an operator-selected complexity; an option to select a time limit for the next set of questions to be presented; or an option to select a starting time of the next set of questions to be presented.

13. The process as claimed in claim 1 which also comprises a third inputting step responding to a second presentation associated with said second inputting wherein said second presentation is based at least in part on at least three operator performance measures associated with said second inputting step and wherein said at least three performance measures associated with said third inputting step are measured.

14. The process as claimed in claim 13 which also comprises a fourth inputting step responding to a third presentation associated with said third inputting wherein said third presentation is based at least in part on at least four operator performance measures associated with said third inputting step and wherein said at least four performance measures associated with said fourth inputting step are measured.

15. An apparatus to assist an operator in the learning of a topic, said apparatus comprising:
a computer;
operator means for inputting data to said computer wherein at least two operator performance measures associated with said inputting data are capable of being measured; and
computing means for outputting a presentation to said operator wherein said presentation comprises one or more randomly-generated questions within a computer-selected complexity and said questions having a computer-selected time limit for responding to said questions, wherein the selection of said complexity and time limit are each based at least in part on said operator performance measures and wherein said complexity is computer-selected from a range of different complexity values.

16. The apparatus as claimed in claim 15 wherein correctness of answers by said operator to said questions and time to answer said questions by said operator are at least two of said operator measures.

17. The apparatus as claimed in claim 16 wherein said presentation is based on three operator measures wherein said third operator measure is a difference between said time limit and said operator's time to answer.

18. The apparatus as claimed in claim 17 which also comprises means for notifying a person other than said operator of at least one of the performance measures generated by said operator.

19. The apparatus as claimed in claim 18 which also comprises means for quantifying a learning benefit received by said operator over a period of time.

20. An electronic learning aid comprising:
memory means for a storing a plurality of request data sets and algorithms, wherein said request data sets and algorithms are capable of generating a plurality of requests for a response by an operator, and further including corresponding response data sets and algorithms related to the appropriateness of said operator responses, at least a portion of said request data sets and algorithms reflecting different levels of intellectual complexity with respect to other data sets and algorithms within said plurality of request data sets and algorithms;
computer means for selecting a first request data set and algorithm from said plurality of request data sets and algorithms wherein said means for selecting is operably connected to said memory means;
means for outputting a presentation at least a portion of which is a request for an operator response operably associated with said memory means wherein said presentation is based at least in part on said first request data set and algorithm;
input means for receiving an operator response to said presentation wherein said operator response comprises operator measures comprising correctness of said response, a time for said response, and a time from any prior response wherein said input means for receiving an operator response is operably connected to said memory means;
means for selecting an algorithm and second request data set having a different level of number of steps required to respond correctly wherein said selection is from a range of different values of intellectual complexity and said selecting is based at least in part from said correctness measure of the initial operator response, said time for said response, and said time from any prior response; and
means for outputting a second presentation at least a portion of which is a second request for an operator response operably associated with said memory means wherein said second presentation is based at least in part on said second request data set and algorithm.
